(19) United States
(12) Patent Application Publication
(10) Pub. No.: US 2016/0171491 A1
(43) Pub. Date: Jun. 16, 2016

(54) METHOD FOR OPERATING AN ID-BASED ACCESS CONTROL SYSTEM

(71) Applicant: SKIDATA AG, GROEDIG/SALZBURG (AT)

(72) Inventors: ANDREAS KERSCHBAUMER, KLAGENFURT (AT); HARALD KOTNIK, KOETTMANNSDORF (AT); MARKUS NOVAK, EGG BEI HERMAGOR (AT)

(21) Appl. No.: 14/966,140

(22) Filed: Dec. 11, 2015

(30) Foreign Application Priority Data
Dec. 11, 2014 (EP) 14197350.3

(51) Int. Cl. G06Q 20/38; H04L 29/06; G06Q 20/14

(52) U.S. Cl. CPC G06Q 20/3821; G06Q 20/14; H04L 63/08

(57) ABSTRACT

In the context of the method for operating an ID-based access control system comprising at least one central server (4) and at least one access control device (2) which can be connected to the at least one central server (4) for the purposes of data communication, each access control device (2) has a zone assigned to it that has a unique zone ID. If a customer medium (1) is registered for the first time with respect to the validity of an access authorization by an online access control device (2) assigned to this zone, an offline data record is written to the customer medium (1), which, in the event that an access control device (2) in the same zone is offline and registers the customer medium (1), is read by the offline access control device (2) and used to determine the validity of the access authorization assigned to the ID of the customer medium (1). The offline data record contains temporal validity information, and in the event that several zones are provided, zone-related validity information, which makes it possible to determine the validity of an access authorization assigned to the ID of the customer medium (1). The offline access control transaction data is stored by the access control device (2) and forwarded to the central server (4) as soon as the access control device (2) returns to an online mode.

### BACKGROUND OF THE INVENTION

The present invention relates to a method for operating a customer identification (“ID”) based personnel or motor vehicle access control system.

In order to determine the validity of an access control authorization, ID-based access control systems use a customer-medium ID which is read by the access control system's access control devices. The ID that is read is transmitted to a central server which, on the basis of the ID, allows or denies access via the access control device transmitting the ID. The customer medium can be realized, for example, as an RFID-tag, as an RFID card, as a paper ticket with machine-readable information, or as an electronic ticket with a one or two-dimensional barcode.

In contrast to so-called “medium-based” access control systems, which allow or deny access on the basis of the information stored in a customer medium without the need for a technical data link to a central server, ID-based access control systems have the advantage of ensuring a high degree of flexibility and scaling. Several types of access authorization, for example for different areas, different times and different operators, can be assigned to a customer-medium ID, which is particularly advantageous at ski resorts. This is not straightforward with medium-based access control systems, however, since the storage capacity of a customer medium is limited so that storage of information relating to a number of access authorizations is not normally possible.

ID-based access control systems, on the other hand, have the disadvantage that the central server and the access control system's access control device must be connected over a network for the purpose of data communication with one another. If an access control device or the central server are offline, there is still a need to maintain the operation of the access control system.

The WO2014/044307A1 reveals a method for operating an access control system, in particular in the event that an access control device is offline, as part of which a central server transmits a positive/negative list to the access control devices which store the list. In the event that an access control device is offline, the validity status of the customer medium is determined by means of the customer-medium ID. The central server then transmits only the changes in the positive/negative list to the access control devices.

In this context there is, however, the disadvantage that the access control devices must have a high storage capacity in order to store the positive/negative list. Furthermore, the lists cannot be used for the purpose of a price calculation in an offline mode.

### SUMMARY OF THE INVENTION

A principal objective of the present invention, therefore, is to provide a method for the operation of an ID-based access control system, comprising at least one central server and at least one access control device, which method, when carried out, will maintain the operation of the access control system in the event that an access control device or a central server is offline.

Accordingly, a method is proposed for the operation of an ID-based access control system with at least one zone which comprises at least one central server and at least one access control device connectable to the at least one central server for the purposes of data communication. In this system, each access control device is assigned to at least one zone, wherein each zone has a unique zone ID. The zones can be spatial and/or temporal zones for the area covered by the access control system. One access control device may have a number of zones assigned to it, and one zone may have a number of access control devices assigned to it.

For example, a zone may be a ski resort or a ski slope, a further zone may be a car park in the ski resort and a third zone, a wellness facility in the ski resort. If a zone is a temporal zone, and if only one spatial zone is provided, the temporal zone may correspond to a given time period. If a zone is a spatial and a temporal zone, this may for example correspond to a given time period in a given spatial zone.

According to the invention, a data record requiring limited storage resources and containing temporal validity information and/or, in the event that multiple zones are provided, zone-related validity information, which makes it possible to determine the validity of an access authorization assigned to the customer-medium ID, is written to the customer medium when the customer medium, with respect to the validity of an access authorization, is first registered in a zone by an online access control device assigned to this zone, i.e. an access control device which is connected to the at least one central server for data communication purposes.

In the event that an access control device which is assigned to the same zone is offline, i.e. is not connected to the at least one central server for data communication purposes, and registers the customer medium, this said data record, hereinafter referred to as an offline data record, is read by the offline access control device and used to determine the validity of an access authorization assigned to the customer-medium ID.

An offline data record according to the invention may contain, for example, just the zone ID of the zone in which the customer medium was registered, the zone ID and a time stamp which corresponds to the time of registration in that zone, or the zone ID, a time stamp and temporal validity information, for example the time of day as from which the access authorization is no longer valid, or temporal validity information differentiated according to the number of days of validity etc.

If the access control system only has one zone, the zone ID is omitted, whereby the size of the offline data record is reduced. The offline data record can also contain just the zone ID and temporal validity information.

When a customer medium is registered in a zone by an access control device, and if the access control device is online, only the customer-medium ID is read and forwarded to the central server. The central server responds with information as to whether the customer-medium has a valid access authorization for that zone and, in the event that this is the first time that the customer-medium has been registered in this zone with respect to a valid access authorization, with an offline data record, which is to be written by the access control device to the customer medium. If the offline data record is successfully written to the customer medium, the access control device transmits a corresponding information to the central server. If the writing of the offline data record is unsuccessful, or if the access control device goes into an offline mode during this operation, no confirmation is sent.

Where access controls are carried out by online access control devices on the aforesaid customer medium in the aforesaid zone, on the evaluation of the validity of the access authorization by means of the customer-medium ID, no offline data record is transmitted via the central server to the respective access control device for writing to the customer medium, since an offline data record has already been written to the customer medium. A further offline data record will only be transmitted via the respective access control device if the customer medium is registered by an online access control device in another zone as described above. In such a case, the offline data records for other zones which are already on the customer medium are not overwritten.

If an access control device in a zone is offline, the customer-medium ID and the offline data record are read by the access control device. Using the temporal validity information and/or the zone-related validity information of the offline data record, in the event that a number of zones are provided, an evaluation is made as to whether there is a valid access authorization for the zone.

This is the case when, for example, if the zone ID, which can be held in the offline data record, matches the zone ID of the access control device, and the time interval between the writing of the offline data record (i.e. a time stamp) and the reading of the offline data record by the access control device falls within the temporal validity of the access authorization, which is held in the offline data record.

If no temporal validity information is held in the offline data record, access will be allowed if the time interval between the writing of the offline data record (i.e. a time stamp) and the reading of the offline data record by the offline access control device does not exceed a given, configurable, time.

The access control device stores the data of the offline access control transaction which is forwarded to the central server as soon as the access control device is in an online mode again.

In the event that an access control device registers, for the first time, in the zone to which it is assigned, a customer medium in relation to the validity of an access authorization and happens to be offline, access will be allowed in terms of a first variation of the method according to the invention, wherein the validity of the customer medium in the same zone can be verified in online mode at a later point in time by a further access control device, or by the same access control device, as is normally the case in ski resorts. Alternatively, access can be denied, wherein the user is invited to go to a cash desk where an offline data record for this zone is written to the customer medium.

Further, in the event that the customer medium is purchased directly in one zone, which can be the case for example in ski resorts, the corresponding offline data record containing, for example, the zone ID where a number of zones exist and a time stamp which corresponds to the time of registration in that zone and/or temporal validity information, can be written to the customer medium at the time of purchase of the customer medium.

According to the invention it is also possible, on the purchase of an access authorization for a number of zones, to write the offline data records for each of these zones to the customer medium.

By synchronizing the access control transactions data as soon as the corresponding access control devices are back in an online mode, so-called clearing is ensured, for example, in a ski resort, since it is possible to calculate in this way, how many customers have used which access control devices, or transport means, in the ski resort.

Further, it is possible according to a further development of the invention, for an offline data record written to a customer medium to be used by a pay station of the access control system for calculating the fees due, if the pay station is offline, i.e. is not connected to the central server. For this purpose the prices and tariffs are stored by the pay stations of the access control system, so that the fee due can be determined on the basis of the stored prices and tariffs and the data in the offline data record.

The offline data records are preferably encrypted, wherein the customer media are implemented such that they can be written to.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a sequence diagram illustrating the first registration of a customer medium in a zone of an online access control device.

FIG. 2 is a sequence diagram illustrating the registration of a customer medium in a zone of an online access control device, in a case where an offline data record for this zone has been written to the customer medium.

FIG. 3 is a sequence diagram illustrating the registration of a customer medium containing an offline data record from an offline access control device.

### DETAILED DESCRIPTION OF THE PREFERRED EMBODIMENTS

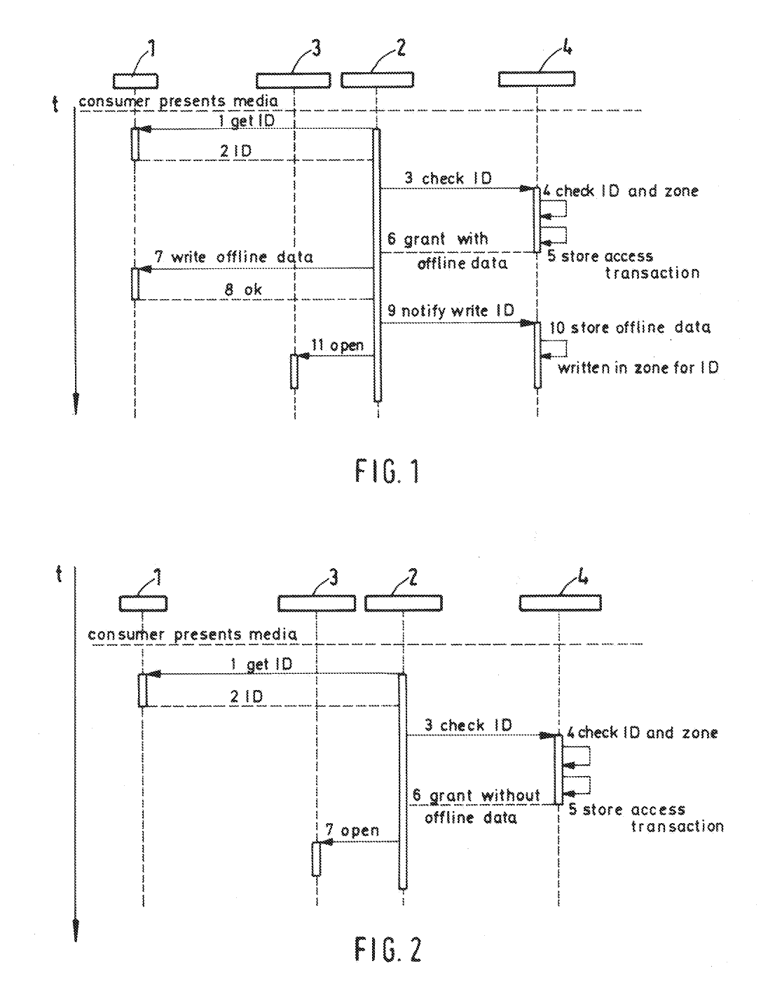

The preferred embodiments of the present invention will now be described with reference to FIGS. 1-3 of the drawings. Identical elements in the various figures are designated with the same reference numerals.

In all figures, reference numeral 1 indicates a customer medium, for example a writable RFID tag, 2 indicates an access control device and 3 a barrier element assigned to the access control device. The access control device 2 is state of the art and comprises, in the case of a customer medium 1 realized as an RFID tag, an antenna unit for communication with the customer medium 1. During an interaction between the access control device 2 and a customer medium 1, data can be read from, as well as written to, the customer medium 1.

On reading a valid access authorization, the barrier element is switched from a closed position to an open position, which allows a person or a vehicle to pass. With access control devices 2 for people, the barrier element may be a turnstile or a flap-gate, wherein in the case of access control devices 2 for motor vehicles the barrier element may be realized as a barrier beam. Further, the figures show a central server of the access control system, which is assigned the reference numeral 4.

In normal operation of the access control system, the access control devices 2 are connected with the at least one central server 4, for example over a local network or over the internet, for the purposes of data communication.

In the event that a customer medium is registered in a zone for the first time with respect to the validity of an access authorization, with reference to FIG. 1, the customer-medium ID is read by an access control device 2 assigned to this zone (steps 1, 2), wherein the customer-medium ID is subsequently transmitted to the central server 4 (step 3), wherein the central server 1 determines, using the customer-medium ID, whether a valid access authorization for this zone exists and whether an offline data record has been written to the customer medium (step 4).

In a next step, the access control transaction data is stored (step 5) and, in the case of a valid access authorization, the information allowing entry and an offline data record which is to be written to the customer medium 1 by the access control device 2 is transmitted to the access control device 2 (step 6). Subsequently (step 7), the offline data record, including for example the zone ID, a time stamp and temporal validity information, is written to the customer medium 1, wherein the successful writing of the offline data record is confirmed by the customer medium (step 8). Then the access control device 2 transmits to the central server 4 the information that the offline data record for the zone has been written to the customer medium 1 (step 9), wherein this information is stored in the central server 4 (step 10). Once the information that the offline data record has been successfully written to the customer medium 1 has been received, the access control device's 2 barrier element 3 is actuated in opening direction in order to allow access (step 11).

The subject of FIG. 2 is the implementation of the method according to the invention in a case where a customer medium 1 is registered, not for the first time, with respect to the validity of an access authorization, by an offline access control device 2. Here, the customer-medium ID is read by virtue of an interaction between the access control device 2 and the customer medium (steps 1, 2), wherein this information is subsequently forwarded to the central server 4 (step 3), where it is determined, using the customer-medium ID, whether a valid access authorization exists and whether an offline data record for the zone has already been written to the customer medium (step 4). Thereafter, the access control transaction data is stored (step 5) and, since an offline data record for this zone has already been written to the customer medium, the message ‘allow access’ is transmitted to the access control device 2 (step 6) without writing an offline data record. The access control device's 2 barrier element 3 is then actuated in opening direction in order to allow access (step 7).

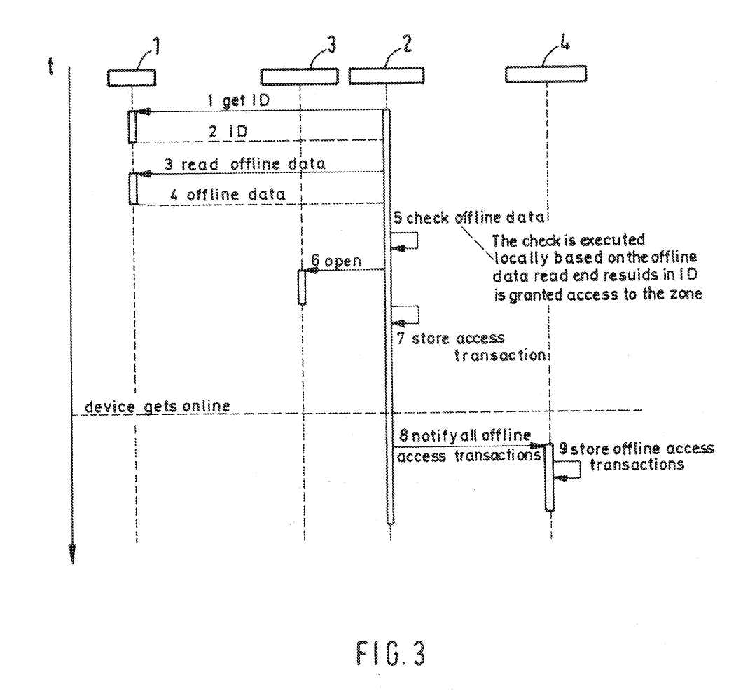

In the event that a customer medium has already been registered in a zone by an online access control device, if the customer medium is again registered by an offline access control device in this zone, and the access control device is offline, the procedure, with reference to FIG. 3, will be as follows.

First, the ID of customer medium 1 is read by the access control device 2 (steps 1, 2), wherein, subsequently, the offline data record is read which was written to the customer medium on the first registration of the customer medium 1 in the same zone (steps 3, 4). In a next step (step 5) the offline data record is evaluated by the access control device 2, wherein if the zone ID, which in the depicted embodiment is held in the offline data record, matches the zone ID of the access control device 2 and the time interval between the writing of the offline data record (i.e. a time stamp) and the reading of the offline data record by the offline access control device 2 falls within the temporal validity of the access authorization which in the depicted embodiment is held in the offline data record, access is allowed by actuating the barrier element 3 of the access control device 2 in opening direction (step 6). The offline access control transaction data is stored locally on the access control device 2 (step 7), wherein, if at a later point in time the access control device 2 changes into an online mode, the transaction data is forwarded to the central server 4 (step 8), where it is stored (step 9).

There has thus been shown and described a novel method for operating an ID-based access control system which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed:

1. In a method for operating an ID-based access control system with at least one zone which comprises at least one central server and at least one access control device that can be connected to the at least one central server for the purposes of data communication, the improvement wherein each access control device has at least one zone assigned to it, which has a unique zone ID; wherein, if a customer medium is registered for the first time with respect to the validity of an access authorization in a zone by an online access control device assigned to that zone, an offline data record is written to the customer medium and, in the event that an access control device, which has the same zone assigned to it, is offline and registers the customer medium, this data record is read by the offline access control device and used to determine the validity of an access authorization assigned to the ID of the customer medium; wherein the offline data record contains temporal validity information and, if a number a zones are provided, zone-related validity information, which makes it possible to determine the validity of an access authorization assigned to the ID of the customer medium; and wherein the offline access control transaction data is stored by the access control device and forwarded to the respective central server as soon as the access control device returns to an online mode.

2. The method for operating an ID-based access control system according to claim 1, wherein, if a customer medium is registered by an access control device in a zone, only the ID of the customer medium is read and forwarded to the central server, wherein the central server responds with information as to whether the customer medium has a valid access authorization for the zone and, in the event that the customer medium is being registered for the first time in relation to the validity of the access authorization in that zone with an offline data record, which is to be written to the customer medium by the access control device; wherein, if the offline data record is successfully written to the customer medium, a corresponding information is transmitted from the access control device to the central server; and wherein, in the case of access controls carried out on the same customer medium by means of online access control devices in the same zone, during the evaluation of the access authorization using the ID of the customer medium via the central server, no offline data record is transmitted to the respective access control device.

3. The method for operating an ID-based access control system according to claim 1, wherein, if an access control device registers a customer medium with respect to the validity of an access authorization for the first time in the zone to which it is assigned and it is offline, access is allowed; and wherein the validity of the customer medium can be verified at a later point in time in an online mode by a further access control device, or by the same access control device.

4. The method for operating an ID-based access control system according to claim 1, wherein, if the customer medium is purchased directly in a zone, the offline data record is written to the customer medium at the time of purchase of the customer medium, and wherein on the acquisition of an access authorization for several zones the offline data records for each of those zones are written to the customer medium.

5. The method for operating an ID-based access control system according to claim 1, wherein an offline data record written to a customer medium is used by a pay station of the access control system if the pay station is offline;
wherein the prices and tariffs are stored by the pay stations of the access control system so that the amount due is determined on the basis of the stored prices and tariffs and the data in the offline data record.
